(19) United States
(12) Patent Application Publication
(10) Pub. No.: US 2020/0229199 A1
(43) Pub. Date: Jul. 16, 2020

(54) COMMUNICATION RESOURCE RELEASE METHOD AND APPARATUS

(71) Applicant: HUAWEI TECHNOLOGIES CO., LTD., Shenzhen (CN)

(72) Inventors: Yang XIN, Shanghai (CN); Xiaobo WU, Shanghai (CN); Weiwei CHONG, Shanghai (CN)

(21) Appl. No.: 16/828,834

(22) Filed: Mar. 24, 2020

Related U.S. Application Data
(63) Continuation of application No. PCT/CN2018/104023, filed on Sep. 4, 2018.

(30) Foreign Application Priority Data
Sep. 25, 2017 (CN) 201710874659.3

(51) Int. Cl. H04W 72/08; H04W 28/02

(52) U.S. Cl. CPC H04W 72/08; H04W 28/0268

(57) ABSTRACT

Embodiments of this application relate to a communication resource release method and apparatus. The method includes: first, receiving, by a first network element of a first communications network, a first removal request for a service data flow from a second network element; and then deleting, based on the first removal request, a first QoS parameter that corresponds to the service data flow and that is of the first communications network and a second QoS parameter that corresponds to the service data flow and that is of a second communications network. In this way, a communication resource release solution can be provided.

### CROSS-REFERENCE TO RELATED APPLICATIONS

This application is a continuation of International Application No. PCT/CN2018/104023, filed on Sep. 4, 2018, which claims priority to Chinese Patent Application No. 201710874659.3, filed on Sep. 25, 2017. The disclosures of the aforementioned applications are hereby incorporated by reference in their entireties.

### TECHNICAL FIELD

This application relates to the field of communications technologies, and in particular, to a communication resource release method and apparatus.

### BACKGROUND

Currently, second generation mobile communications technology/third generation mobile communications technology (2G/3G) networks have been widely deployed in many areas. With rapid development of communications technologies, networks such as long term evolution ( ) networks have covered some urban areas and traffic hotspot areas. In addition, new generation networks, namely, fifth generation mobile communications technology (5G) networks, are also being deployed. Therefore, there will be areas in which the 5G networks coexist with the LTE networks or the 5G networks coexist with the 2G/3G networks in the future. In view of this, inter-system interworking is introduced to an existing communications system. Interworking is an important guarantee for service continuity between different systems. By using inter-system interworking, an operator can implement complementation between networks of different systems, improve coverage of an existing network, and improve network quality.

However, in existing inter-system interworking, a communication resource release method may cause a communication exception.

### SUMMARY

In view of this, this application provides a communication resource release method and apparatus, to provide a communication resource release solution.

According to a first aspect, an embodiment of this application provides a communication resource release method. The method includes: receiving, by a first network element of a first communications network, a first removal request for a service data flow (SDF) from a second network element; and then deleting, based on the first removal request, a first quality of service (QoS) parameter that corresponds to the service data flow and that is of the first communications network and a second QoS parameter that corresponds to the service data flow and that is of a second communications network.

In this way, a network-side network element in the first communications network removes, while releasing the first QoS parameter that corresponds to an SDF and that is of the first communications network, the second QoS parameter that corresponds to the SDF and that is of the second communications network. This ensures that a communication resource is not occupied, and interworking between the first communications network and the second communications network can be smoothly performed, thereby improving network resource utilization.

In one embodiment, the foregoing method further includes: determining, by the first network element, that there is only one service data flow in a bearer that corresponds to the service data flow and that is of the second communications network, and deleting, by the first network element, a bearer identifier of the bearer. In other words, a session management function (SMF) network element and a user equipment (UE) network element delete, in a timely manner, the bearer identifier of the bearer that corresponds to the SDF and that is of an LTE network.

In one embodiment, the first network element determines that there is only one service data flow in a QoS flow that corresponds to the service data flow and that is of the second communications network; and the first network element deletes a quality of service flow identifier (QFI) of the QoS flow. In other words, a packet data network gateway control plane (PGW-C) network element and a UE network element delete, in a timely manner, the QFI of the QoS flow that corresponds to the SDF and that is of a 5G network.

Further, In one embodiment, when the first network element is an SMF network element, and the second network element is a terminal or a PCF network element, the SMF network element sends a second removal request to an AMF network element of the first communications network, where the second removal request is used to request the AMF network element to release the bearer identifier of the bearer that corresponds to the service data flow and that is of the second communications network. This means that the AMF network element removes a correspondence between the bearer identifier and the bearer in a timely manner, so that the LTE network that subsequently interworks with the 5G network prepares a context.

In one embodiment, when the first network element is a PGW-C network element, the PGW-C network element releases the QFI of the QoS flow that corresponds to the bearer and that is of the second communications network. This means that the PGW-C network element removes a correspondence between the QFI and the QoS flow in a timely manner, so that the 5G network that subsequently interworks with the LTE network prepares a context.

It should be noted that, if in the foregoing method, the first communications network is a 5G network, and the second communications network is an LTE network, the first QoS parameter includes at least one of a QI, a session aggregate maximum bit rate (AMBR), and an allocation retention priority (ARP) that correspond to a default QoS flow, and the second QoS parameter includes at least one of a QoS classification identifier (QCI), an access point name-aggregate maximum bit rate (APN-AMBR), and an ARP that correspond to a default bearer; or
the first QoS parameter includes at least one of a 5G QoS indicator (5 QI), a Guaranteed Bit Rate (GBR), and an ARP that correspond to a dedicated QoS flow, and the second QoS parameter includes at least one of a QCI, an APN-AMBR, and an ARP that correspond to a dedicated bearer.

If in the foregoing method, the first communications network is an LTE network, and the second communications network is a 5G network, the first QoS parameter includes at least one of a QCI, an APN-AMBR, and an ARP that correspond to a default bearer, and the second QoS parameter includes at least one of a 5 QI, a session AMBR, and an ARP that correspond to a default QoS flow; or
the first QoS parameter includes at least one of a QCI, an APN-AMBR, and an ARP that correspond to a dedicated bearer, and the second QoS parameter includes at least one of a 5 QI, a GBR, and an ARP that correspond to a dedicated QoS flow.

In one embodiment, if the first network element in the foregoing method is an SMF network element in the 5G network, the second network element is UE, a PCF network element, or an application function entity; or if the first network element in the foregoing method is a PGW-C network element in the LTE network, the second network element is UE, a policy and charging rules function (PCRF) network element, or an application function entity.

In one embodiment, if the first network element in the foregoing method is UE, the second network element may be an SMF network element in the 5G network or a PGW-C network element in the LTE network.

In one embodiment, if the first network element in the foregoing method is a PCF network element, the second network element may be an SMF network element in the 5G network; or if the first network element is a PCRF network element, the second network element may be a PGW-C network element in the LTE network.

In addition, in one embodiment, the removal request in the foregoing method may further include release indication information. Alternatively, the first removal request further includes the QoS parameter that corresponds to the service data flow and that is of the first communications network.

According to a second aspect, an embodiment of this application further provides a communication resource release apparatus. The apparatus has a function of implementing behavior of the first network element in the method examples according to the first aspect. The function may be implemented by using hardware, or may be implemented by hardware by executing corresponding software. The hardware or the software includes one or more modules corresponding to the function.

In one embodiment, a structure of the apparatus includes a receiving unit, a sending unit, and a processing unit. These units may perform corresponding functions in the foregoing method examples. The receiving unit is configured to receive a first removal request for a service data flow from a second network element. The processing unit is configured to delete, based on the first removal request, a first quality of service QoS parameter that corresponds to the service data flow and that is of a first communications network and a second QoS parameter that corresponds to the service data flow and that is of a second communications network.

In this way, the communication resource release apparatus removes, while releasing the first QoS parameter that corresponds to an SDF and that is of the first communications network, the second QoS parameter that corresponds to the SDF and that is of the second communications network. This ensures that a communication resource is not occupied, and interworking between the first communications network and the second communications network can be smoothly performed, thereby improving network resource utilization.

In one embodiment, the processing unit is configured to determine that there is only one service data flow in a bearer that corresponds to the service data flow and that is of the second communications network; and delete a bearer identifier of the bearer.

In one embodiment, the processing unit is configured to determine that there is only one service data flow in a QoS flow corresponds to the service data flow and that is of the second communications network; and delete a QFI of the QoS flow.

When the second network element is a terminal or a policy control network element, the apparatus further includes: a sending unit 603, configured to send a second removal request for the service data flow to an access management network element of the first communications network, where the second removal request is used to request the access management network element to release the bearer identifier of the bearer that corresponds to the service data flow and that is of the second communications network.

In one embodiment, when the communication resource release apparatus is integrated into a control plane network element of an LTE network, the processor 602 is further configured to: release the QFI of the QoS flow that corresponds to the bearer and that is of the second communications network.

In one embodiment, the first QoS parameter includes at least one of a 5 QI, a session AMBR, and an ARP that correspond to a default QoS flow, and the second QoS parameter includes at least one of a QCI, an APN-AMBR, and an ARP; or the first QoS parameter includes at least one of a 5 QI, a GBR, and an ARP that correspond to a dedicated QoS flow, and the second QoS parameter includes at least one of a QCI, an APN-AMBR, and an ARP that correspond to a dedicated bearer.

In one embodiment, the first QoS parameter includes at least one of a QCI, an APN-AMBR, and an ARP that correspond to a default bearer, and the second QoS parameter includes at least one of a 5 QI, a session AMBR, and an ARP that correspond to a default QoS flow; or
the first QoS parameter includes at least one of a QCI, an APN-AMBR, and an ARP that correspond to a dedicated bearer, and the second QoS parameter includes at least one of a 5 QI, a GBR, and an ARP that correspond to a dedicated QoS flow.

Preferably, the first removal request may include release indication information. Alternatively, the first removal request includes the QoS parameter that corresponds to the service data flow and that is of the first communications network.

The communication resource release apparatus in the foregoing embodiment may be UE, or may be one of a PCF network element, an AMF network element, and a PGW-C network element.

According to a third aspect, an embodiment of this application further provides a communication resource release apparatus. The apparatus has a function of implementing behavior of the first network element in the method examples according to the first aspect. The function may be implemented by hardware. A structure of the apparatus includes a communications interface, a processor, and a memory. The processor invokes an instruction stored in the memory, to perform the foregoing methods.

According to a fourth aspect, an embodiment of this application further provides a computer storage medium. The storage medium stores a software program. When being read and executed by one or more processors, the software program may implement the method according to any one of the first aspect or the designs of the first aspect.

According to a fifth aspect, this application further provides a computer program product including an instruction. When the computer program product is run on a computer, the computer is enabled to perform the communication resource release method according to the foregoing aspects or the foregoing possible embodiments.

Compared with a conventional resource release manner, in the communication resource release method provided in the embodiments of this application, while a communication resource of a network in which a service data flow of a terminal is currently located is released, a communication resource of a target network that interworks with a current network is also released. This ensures that the communication resource is not occupied, and interworking between the first communications network and the second communications network may be smoothly performed, thereby improving network resource utilization.

### BRIEF DESCRIPTION OF DRAWINGS

FIG. 1 is a schematic diagram of a communications system according to an embodiment of this application;

FIG. 2 is a schematic diagram of a PDU session in a 5G network according to an embodiment of this application;

FIG. 3 is a schematic diagram of a PDN connection in an LTE network according to an embodiment of this application;

FIG. 4 is a schematic interaction diagram of a communication resource release method according to an embodiment of this application;

FIG. 5 is a schematic interaction diagram of another communication resource release method according to an embodiment of this application;

FIG. 6 is a schematic structural diagram of a communication resource release apparatus according to an embodiment of this application; and

FIG. 7 is a schematic structural diagram of another communication resource release apparatus according to an embodiment of this application.

### DESCRIPTION OF EMBODIMENTS

The following further describes in detail this application with reference to accompanying drawings.

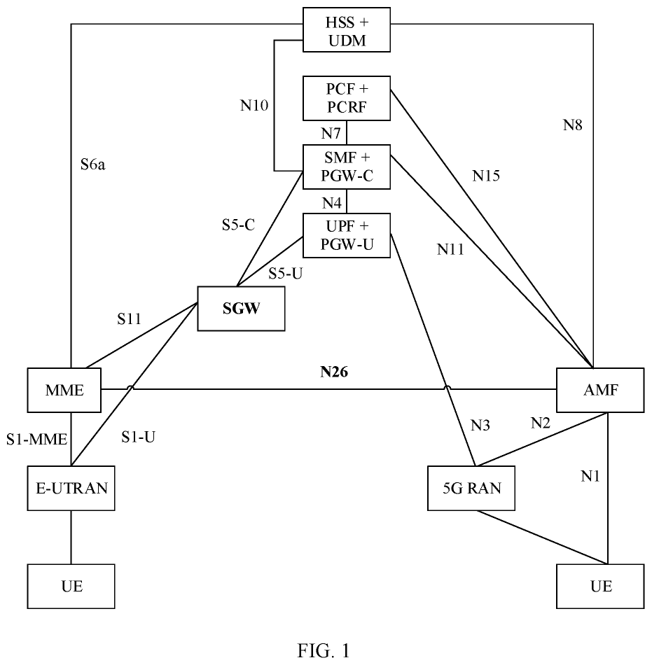

A communication resource release method in this application may be applied to a plurality of system architectures. FIG. 1 is a schematic diagram of a communications system to which this application is applied. Specifically, FIG. 1 is a schematic architectural diagram of interworking between an LTE network and a 5G network. In the communications system, the LTE network includes: an evolved universal terrestrial radio access network (EUTRAN), a mobility management function (MME) network element, a serving network element (SGW), a packet data network gateway control plane (PGW-C) network element, a packet data network gateway user plane (PGW-U) network element, a policy and charging rules function (PCRF) network element, a home subscriber server (HSS) network element, and the like.

The 5G network includes: a fifth generation radio access network (5G RAN), an access and mobility management function (AMF) network element, a user plane function (UPF) network element, an SMF network element, a policy and charging function (PCF) network element, a unified data management (UDM) network element, and the like.

It should be noted that the SMF network element and the PGW-C network element in FIG. 1 may be integrated, or may be separately disposed in different devices. Similarly, the UPF network element and the PGW-U network element, the HSS network element and the UDM network element, and the PCF network element and the PCRF network element may also be disposed in a same manner. A composition mode of these networks is not specifically limited in this embodiment of this application.

The communications system shown in FIG. 1 is a network architecture that can meet interworking between the LTE network and the 5G network. In the communications system, the PGW-C network element and the SMF network element are integrated, the PGW-U network element and the UPF network element are integrated, the PCF network element and the PCRF network element are integrated, and a user plane of UE is anchored to the integrated UPF network element and PGW-U network element. An N26 interface is disposed between the AMF network element and the MME network element, and a cross-system handover request is sent on the interface. In this way, when a terminal is handed over between the LTE network and the 5G network, a seamless handover can be ensured.

The terminal in this application may include a handheld device, a vehicle-mounted device, a wearable device, or a computing device having a wireless communication function, another processing device connected to a wireless modem, UE in various forms, a mobile station (MS), a terminal (terminal), terminal equipment, or the like. For ease of description, in this embodiment of this application, an example in which the terminal is the UE is used for description.

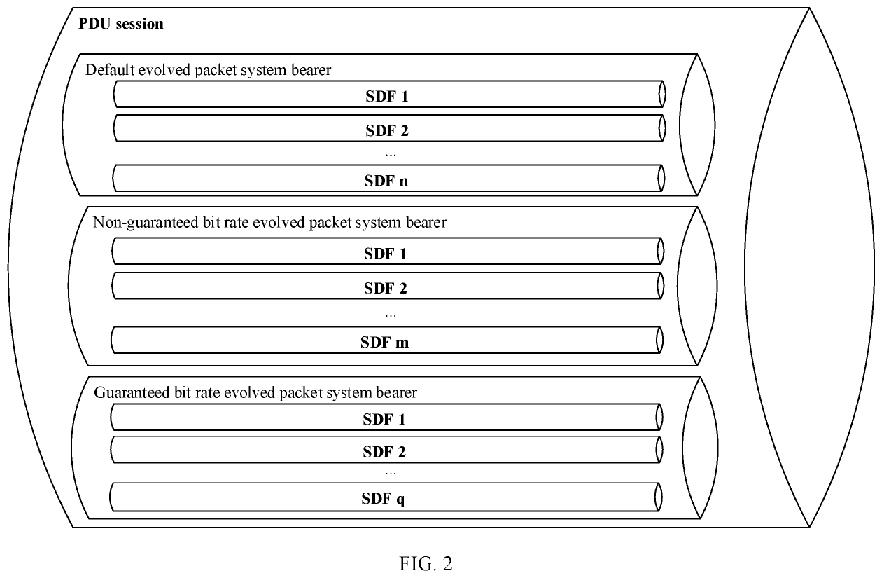

In the LTE network, the UE and the network establish a PDN connection. At least one bearer may be established in each PDN connection, and an internal structure of the PDN connection is shown in FIG. 2. Main features are as follows.

(1). A PDN connection corresponds to an access point name (APN) and an access point name-aggregate maximum bit rate (APN-AMBR). In a UE attach process, the APN and the APN AMBR are obtained by an MME from an HSS in a location request process.

(2). In a PDN connection, there is one and only one default evolved packet system bearer (default EPS bearer) that is created in a PDN connection establishment process, and a default EPS bearer may aggregate at least one service data flow. A PDN connection may further include one or more non-guaranteed bit rate evolved packet system bearers (Non GBR EPS bearer) that are created in a process of establishing a dedicated evolved packet system bearer (dedicated EPS bearer) initiated by the UE or on a network side, and a non-GBR EPS bearer includes at least one SDF, or may aggregate one or more other SDFs. A PDN connection may further include one or more guaranteed bit rate evolved packet system bearers (GBR EPS bearer) that are created in a process of establishing a dedicated EPS bearer initiated by the UE or on the network side, and a GBR EPS bearer has at least one SDF, or may aggregate one or more other SDFs.

Each bearer in FIG. 2 has a corresponding QoS parameter and is used to transmit a corresponding SDF. The MME network element allocates a bearer identifier (bearer ID) to each bearer, and sends the bearer identifier to the UE in a process of establishing the bearer. For a default bearer, the bearer ID is sent to the UE in a PDN connection establishment process, and for a dedicated bearer, the bearer ID is sent to the UE in a dedicated bearer establishment process.

A QoS parameter of the default bearer is different from a QoS parameter of the dedicated bearer, and QoS parameters corresponding to different types of bearers are shown in Table 1.

TABLE 1

| | |
|---|---|
| default EPS bearer | Information such as a QCI, an APN-AMBR, and |
| | an allocation and retention priority (ARP) |
| dedicated (GBR or | Information such as a QCI, an uplink service |
| Non GBR) EPS | template flow and a downlink service template |
| bearer | flow, Precedence, a priority, a GBR, an MBR, and |
| | an ARP |

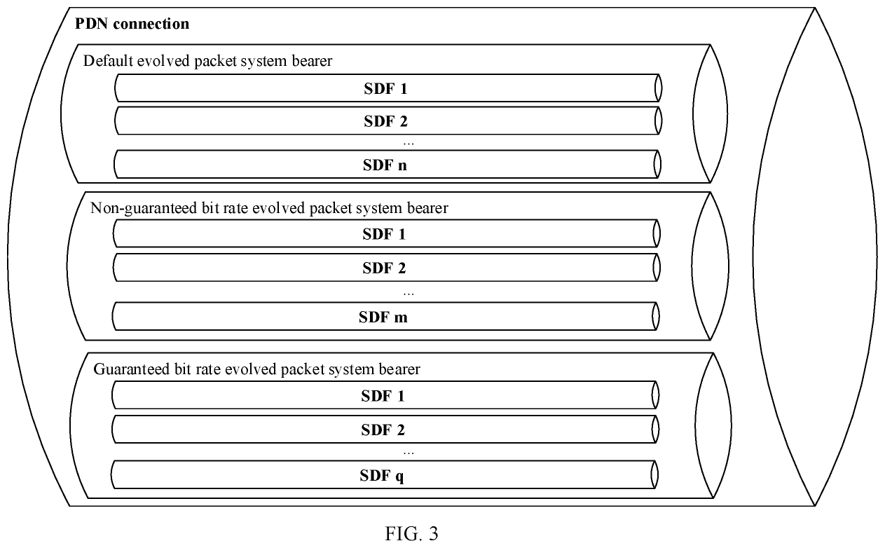

In the 5G network, the UE and the network establish a PDU session. At least one quality of service flow (QoS flow) may be established in each PDU session, and an internal structure of the PDU session is shown in FIG. 3. Main features are as follows.

(1). A PDU session corresponds to a DNN, a PDU session identifier (PDU Session ID), and a session aggregation maximum bit rate (AMBR). In a UE registration process, the DNN and the session AMBR are obtained by an AMF from a UDM in a location request process. The PDU session ID is allocated by an SMF network element to the PDU session in a PDU session establishment process initiated by the UE.

(2). In a PDU session, there is one and only one default QoS flow (that is created in a PDU session establishment process, and a default QoS flow may aggregate at least one SDF. A PDU session may further include one or more non-guaranteed bit rate evolved packet system quality of service flows (Non GBR QoS flow) that are created in a PDU session modification process initiated by the UE or on a network side, and a non-GBR QoS flow includes at least one SDF, or may aggregate a plurality of SDFs. A PDN connection may further include one or more guaranteed bit rate evolved packet system quality of service flows (GBR QoS flow) that are created in a PDU session modification process initiated by the UE or on the network side, and a GBR QoS flow has at least one SDF, or may aggregate a plurality of SDFs.

Each QoS flow in FIG. 3 has a corresponding QoS parameter and is used to transmit a corresponding service data flow. The SMF network element allocates a quality of service flow identifier (QFI) to each QoS flow, and sends the QFI to the UE. For the default quality of service flow, the QFI is sent to the UE in a PDU session establishment process, and for a dedicated quality of service flow, the QFI is sent to the UE in a process of establishing the dedicated quality of service flow

A QoS parameter of the default quality of service flow is different from a QoS parameter of the dedicated quality of service flow, and QoS parameters corresponding to different types of quality of service flows are shown in Table 2.

TABLE 2

| | |
|---|---|
| default QoS flow | Information such as a 5G QoS indicator (5QI), a |
| | Session AMBR, and an ARP |
| dedicated (GBR or | Information such as a 5QI, an uplink packet filter |
| Non GBR) QoS | and a downlink packet filter, a priority |
| flow | (Precedence), a guaranteed bit rate (GBR), a |
| | maximum bit rate (MBR), notification message, |
| | and an ARP |

In this embodiment of this application, the QoS parameters in Table 1 and Table 2 are merely examples for description. The QoS parameter may include one or more of the foregoing parameters. This is not limited in this embodiment of this application.

In conclusion, in interworking between the LTE network and the 5G network, the PDU session corresponds to the PDN connection, and the bearer corresponds to the QoS flow. Specifically, the correspondence is shown in Table 3.

TABLE 3

| | |
|---|---|
| LTE network | 5G network |
| PDN session | PDN connection |
| default EPS bearer | default QoS flow |
| Non GBR EPS bearer | Non GBR QoS flow |
| GBR EPS bearer | GBR QoS flow |
| Bearer ID | QFI |
| QCI | 5QI |
| APN-AMBR | Session AMBR |

In the prior art, to implement the interworking between the 5G network and the LTE network, before the terminal is handed over from the 5G network to the LTE network, the AMF network element in the 5G network allocates the bearer ID to the default EPS bearer corresponding to the default QoS flow, or the AMF network element allocates the bearer ID to the GBR EPS bearer corresponding to the GBR QoS flow. In addition, the 5G network further configures, for the default EPS bearer or the GBR EPS bearer, context information, for example, information such as a QoS parameter and a traffic flow template (TFT). The bearer ID may be configured in a context, or may not be configured in a context. In a process of handing over the terminal from the 5G network to the LTE network, correspondingly, information such as the EPS bearer ID, the QoS parameter, and the TFT can be sent to an LTE network side, so that the default EPS bearer or the GBR EPS bearer is quickly established on the LTE network side, to ensure service continuity of an important service. However, because a quantity of bearer identifiers in the LTE network is limited, if a bearer identifier that is not used in the LTE network is not released in a timely manner before the terminal is handed over from the 5G network to the LTE network, an available bearer identifier may not be successfully obtained by the AMF network element in a handover process. Consequently, the handover fails. At present, there is no corresponding communication resource release solution in the prior art.

Similarly, in a process of handing over the terminal from the LTE network to the 5G network, the PGW-C network element in the LTE network allocates a QFI to the default QoS flow corresponding to the default EPS bearer, or the PGW-C network element allocates a QFI to the GBR QoS flow corresponding to the GBR EPS bearer. In addition, the 5G network further configures context information, for example, information such as a QoS parameter, for the default QoS flow or the GBR QoS flow. The QFI may be configured in a context, or may not be configured in a context. In a process of handing over the terminal from the 5G network to the LTE network, correspondingly, information such as the QFI and the QoS parameter can be sent to a 5G network side, so that the default QoS flow or the GBR QoS flow is quickly established on the 5G network side, to ensure service continuity of an important service. However, because a quantity of QFIs in the 5G network is limited, if a QFI that is not used in the 5G network is not released in a timely manner before the terminal is handed over from the LTE network to the 5G network, an available QFI may not be successfully obtained by the PGW-C network element in a handover process. Consequently, the handover fails.

In addition, at present, because a quantity of bearers in an LTE network is inconsistent with a quantity of QoS flows in a 5G network, and a bearer in the LTE network is inconsistent with an SDF aggregation technology in the 5G network. If the service data flow is simply released according to the method in which the LTE network and the 5G network are in a one-to-one correspondence, a QoS flow or a bearer that does not need to be released is released. Consequently, communication is abnormal.

In view of this, the embodiments of this application provide a communication resource release method. In this method, communication resources of an LTE network and a 5G network can be released in a timely manner, to ensure that the communication resources are not occupied.

With reference to the system architecture shown in FIG. 1, in the embodiments of this application, the communication resource release method in this application is separately described in detail by using Embodiment 1 and Embodiment 2.

### Embodiment 1

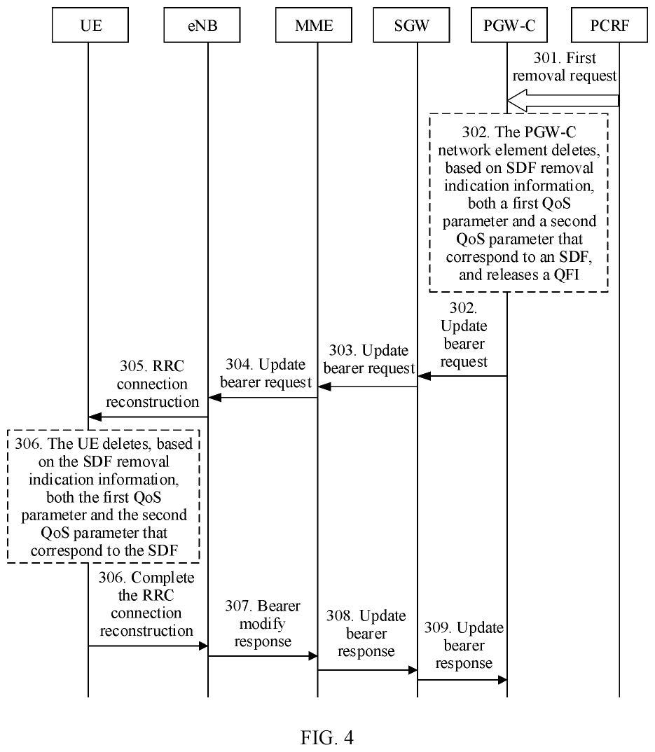

It is assumed that a network in which UE is currently located, that is, a first communications network, is an LTE network, a target network that interworks with the LTE network, that is, a second communications network, is a 5G network. FIG. 4 is an interaction diagram of a communication resource release method according to Embodiment 2 of this application. Specific content is as follows.

Operation 301. A PCRF network element initiates a first removal request for an SDF to a PGW-C network element. The first removal request may be initiated by using an IP-connectivity access network (IP-connectivity access network, IP-CAN) session modify request. The first removal request carries SDF removal indication information.

Operation 302. The PGW-C network element deletes, based on the SDF removal indication information, both a first QoS parameter and a second QoS parameter that correspond to an SDF, where the first QoS parameter is a QoS parameter of an LTE network, and the second QoS parameter is a QoS parameter of a 5G network.

In one embodiment, the PGW-C network element may delete context information corresponding to the SDF in the LTE network and context information corresponding to the SDF in the 5G network. The context information corresponding to the SDF in the LTE network includes the first QoS parameter and/or a bearer identifier. The context information corresponding to the SDF in the 5G network includes the second QoS parameter and/or a QFI.

Specifically, a method for deleting the context information corresponding to the 5G network may be: The PGW-C network element determines whether a QoS flow in which the SDF is located has only one SDF, and if yes, the PGW-C network element deletes a QoS parameter corresponding to the SDF and a QFI of the QoS flow in which the SDF is located; and then, the PGW-C network element releases QFI resources (that is, removes a binding relationship between the QFI and the QoS flow), so that another QoS flow uses the QFI. Otherwise, the PGW-C network element deletes only the QoS parameter corresponding to the SDF, and reserves the QFI.

Specific content of the first QoS parameter is related to a specific type of the bearer that is of the LTE network and in which the SDF is located. Assuming that the bearer in which the SDF is located is a default EPS bearer, the specific content of the first QoS parameter is shown in the first row in Table 1. If the bearer in which the SDF is located is a dedicated EPS bearer, the specific content of the first QoS parameter is shown in the second row in Table 1. Similarly, specific content of the second QoS parameter is related to a specific type of the QoS flow in which the SDF is located. Assuming that the QoS flow in which the SDF is located is a default QoS flow, the specific content of the second QoS parameter is shown in the first row in Table 2. If the QoS flow in which the SDF is located is a dedicated QoS flow, the specific content of the second QoS parameter is shown in the second row in Table 2.

Then, the PGW-C network element sends an update bearer request (Update Bearer Request) message to an SGW network element, and the message carries the SDF removal indication information.

Operation 303. The SGW network element sends the update bearer request message to an MME network element. The message carries the SDF removal indication information.

Operation 304. After receiving the update bearer request message, the MME network element sends a bearer modify request (Bearer Modify Request) message to a base station (eNB), and the message carries the SDF removal indication information.

Operation 305. The eNB sends an RRC connection reconfiguration (RRC Connection Reconfiguration) message to the UE, and the message carries the SDF removal indication information.

Operation 306. The UE receives the RRC connection reconfiguration message; and the UE determines whether the QoS flow in which the SDF is located has only one SDF, and if yes, the UE deletes a QoS parameter corresponding to the SDF and a QFI of a 5G QoS flow in which the SDF is located. Otherwise, the UE deletes only the QoS parameter corresponding to the SDF, and reserves the QFI. Similarly, specific content of the QoS parameter is related to a specific type of the QoS flow in which the SDF is located, and details are not described herein again.

Operation 307 to operation 309. The eNB feeds back an update bearer response message to the MME, the SGW, and the PGW.

It can be learned from FIG. 4 that when an SDF is removed, if the SDF belongs to only one SDF in a QoS flow in the 5G network, the PGW-C network element and the UE delete a QoS parameter and a QFI that correspond to the QoS flow. In addition, the PGW-C network element releases the QFI, that is, removes a binding relationship between the QFI and the QoS flow. Otherwise, if another SDF is further aggregated in the QoS flow in which the SDF is located, the PGW-C network element and the UE delete only the QoS parameter corresponding to the QoS flow. It should be noted that the PGW-C network element may simultaneously delete the QoS parameter and the QFI that correspond to the QoS flow, or may first delete the QFI and then delete the QoS parameter. This is also applicable to the UE. This is not particularly limited in this embodiment of this application.

In addition, another embodiment of operation 301 may alternatively be: A terminal or an application function (AF) network element initiates the first removal request for the SDF to the PGW-C network element. A subsequent communication resource release process is consistent with the foregoing operations. Therefore, details are not described herein again.

### Embodiment 2

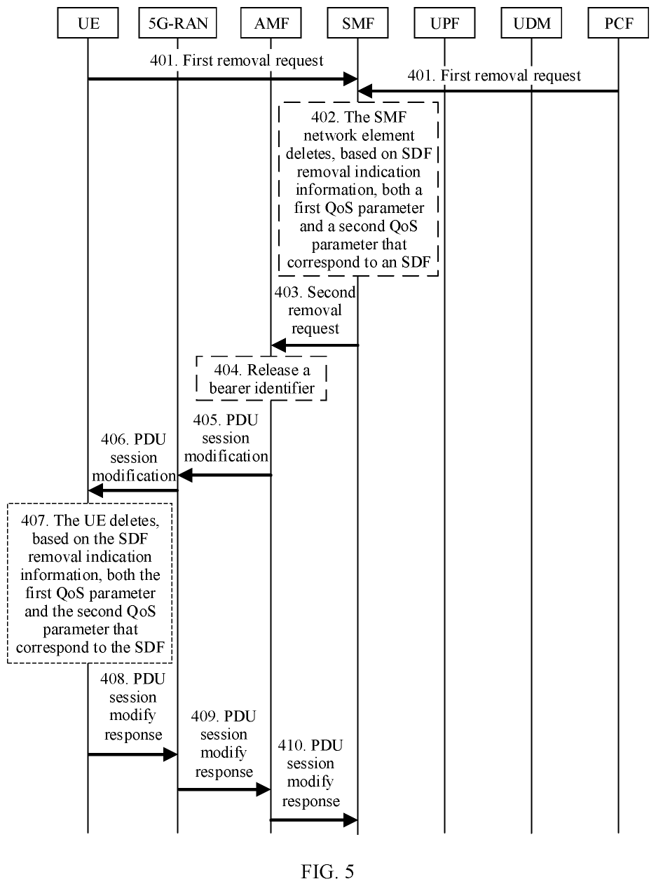

It is assumed that a network in which UE is currently located, that is, a first communications network, is a 5G network, a target network that interworks with the 5G network, that is, a second communications network, is an LTE network. FIG. 5 is an interaction diagram of a communication resource release method according to Embodiment 2 of this application. Specific content is as follows.

Operation 401. UE or a PCF network element initiates a first removal request to an SMF network element, and the first removal request may be initiated by using a PDU session management process, for example, a PDU session. The first removal request carries SDF removal indication information.

Operation 402. The SMF network element deletes, based on the SDF removal indication information, both a first QoS parameter and a second QoS parameter that correspond to an SDF, where the first QoS parameter is a QoS parameter of a 5G network, and the second QoS parameter is a QoS parameter of an LTE network.

In one embodiment, the SMF network element may delete context information corresponding to the SDF in the LTE network and context information corresponding to the SDF in the 5G network. The context information corresponding to the SDF in the LTE network includes the second QoS parameter and/or a bearer identifier. The context information corresponding to the SDF in the 5G network includes the first QoS parameter and/or a QFI.

Specifically, a method for deleting the context information corresponding to the LTE network may be: If the SMF network element determines that a to-be-removed SDF is independently in a GBR QoS flow, the SMF network element deletes a policy and charging control rule (Policy and Charging Control Rule-PCC Rule, PCC rule) (namely, the first QoS parameter of the 5G network) that corresponds to the SDF and that is of the 5G network. Otherwise, in other words, if an SDF other than the to-be-removed SDF is aggregated in the GBR QoS flow, the SMF network element deletes only the PCC rule that corresponds to the SDF and that of the 5G network and a PCC rule of the LTE network, and reserves an EPS bearer ID of the GBR EPS bearer corresponding to the GBR QoS flow in which the SDF is located. Similarly, specific content of the second QoS parameter is related to a specific type of a bearer of the LTE network in which the SDF is located, and specific content of the first QoS parameter is related to a specific type of the QoS flow in which the SDF is located. Details are not described herein again.

Operation 403. The SMF network element sends a second removal request to the AMF network element, and the second removal request is sent by the SMF network element when the SMF network element determines that the SDF is the only one SDF in the bearer, and is mainly used to instruct the AMF network element to release the EPS bearer ID of the GBR EPS bearer corresponding to the GBR QoS flow.

Operation 404. The AMF network element releases the EPS bearer ID of the GBR EPS bearer corresponding to the GBR QoS flow, that is, removes a binding relationship between the EPS bearer ID and the GBR EPS bearer.

Operation 405. The AMF network element sends an update bearer (Update Bearer Request) message to a 5G-RAN by using a NAS message.

Operation 406. The RAN sends a PDU session modify message to the UE, to instruct the UE to modify the PDU session.

Operation 407. If the UE determines that the to-be-removed SDF is independently in the GBR QoS flow, the UE deletes the 5G PCC rule (that is, the QoS parameter of the 5G network) and the LTE network PCC rule (that is, the QoS parameter of the LTE network) that correspond to the SDF. Otherwise, in other words, if an SDF other than the to-be-removed SDF is aggregated in the GBR QoS flow, the UE deletes only the 5G PCC rule and the LTE network PCC rule that correspond to the SDF, and reserves the EPS bearer ID of the GBR EPS bearer corresponding to the GBR QoS flow in which the SDF is located.

Operation 408. The UE sends the NAS message to the 5G-RAN by using NAS SM signaling, to respond to the PDU session modify message.

Operation 409. The 5G-RAN sends a response message to the AMF network element, to respond to the bearer update message.

Operation 410. The AMF network element forwards the response message from the RAN to the SMF network element by using an Nsmf_PDU session update SM context (Nsmf_PDUSession_UpdateSMContext) service operation.

In Embodiment 2, a key is a case in which an SDF is removed from a PDU session. The SDF is only for a case in which an SDF in a dedicated quality of service flow (GBR/non GBR QoS flow) is removed, because the PDU session does not exist once the SDF in the default QoS flow is removed. Therefore, Embodiment 2 focuses only on a case in which an SDF of a GBR QoS flow is removed from a PDU session. In addition, a communication resource is released based on a current aggregation status of the SDF. If only the to-be-removed SDF exists in the GBR QoS flow in which the to-be-removed SDF is located, it means that the entire GBR QoS flow needs to be deleted. If another SDF is further aggregated in the GBR QoS flow in which the to-be-removed SDF is located, the entire GBR QoS flow cannot be directly deleted. In this case, only a QoS parameter corresponding to the SDF needs to be deleted. In this way, when the SDF is removed, not only a 5G context corresponding to the SDF is removed, but also an LTE network context corresponding to the SDF can be deleted in a timely manner, so that an occupied communication resource can be released in a timely manner, thereby improving network resource utilization.

In this embodiment of this application, message names of the foregoing operations are merely names used for ease of understanding. Names of the foregoing messages may alternatively be other names, such as a first message, a second message, or a third message. This is not limited in this application.

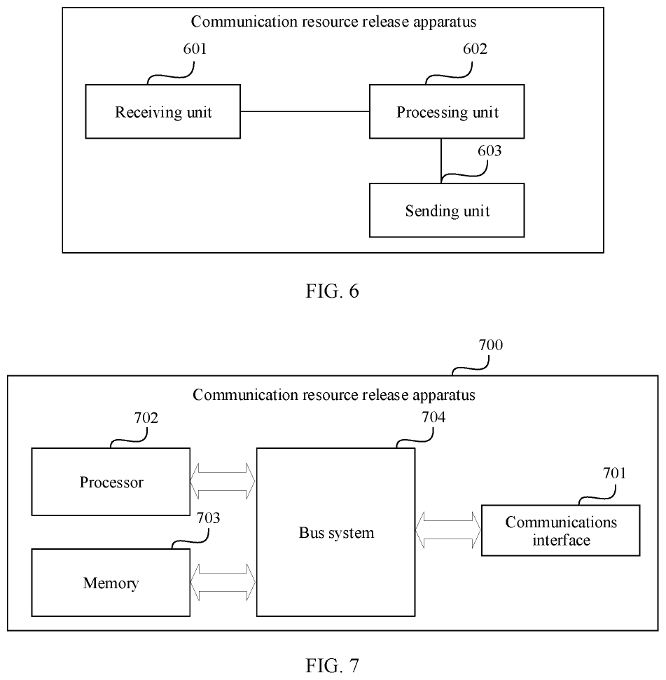

For the foregoing method procedure, this application provides a communication resource release apparatus. For specific content performed by the apparatus, refer to the foregoing method embodiments. FIG. 6 is a schematic structural diagram of a communication resource release apparatus according to this application. The apparatus includes: a receiving unit 601 and a processing unit 602.

The receiving unit 601 is configured to receive a first removal request for a service data flow from a second network element.

The processing unit 602 is configured to delete, based on the first removal request, a first quality of service QoS parameter that corresponds to the service data flow and that is of a first communications network and a second QoS parameter that corresponds to the service data flow and that is of a second communications network.

In one embodiment, the processing unit 602 is configured to: determine that there is only one service data flow in a quality of service flow QoS flow corresponding to the service data flow; and delete a bearer identifier of a bearer that corresponds to the QoS flow and that is of the second communications network.

In one embodiment, the processing unit 602 is configured to: determine that there is only one service data flow in the bearer corresponding to the service data flow; and delete a quality of service flow identifier QFI of a QoS flow that corresponds to the bearer and that is of the second communications network.

When the second network element is a terminal or a policy control network element, the apparatus further includes: a sending unit 603, configured to send a second removal request for the service data flow to an access management network element of the first communications network, where the second removal request is used to request the access management network element to release the bearer identifier of the bearer that corresponds to the service data flow and that is of the second communications network.

In one embodiment, when the communication resource release apparatus is integrated into a control plane network element of an LTE network, the processing unit 602 is further configured to: release the QFI of the QoS flow that corresponds to the bearer and that is of the second communications network.

In one embodiment, the first QoS parameter includes at least one of a 5 QI, a session AMBR, and an ARP that correspond to a default QoS flow, and the second QoS parameter includes at least one of a QCI, an APN-AMBR, and an ARP; or the first QoS parameter includes at least one of a 5 QI, a GBR, and an ARP that correspond to a dedicated QoS flow, and the second QoS parameter includes at least one of a QCI, an APN-AMBR, and an ARP that correspond to a dedicated bearer.

In one embodiment, the first QoS parameter includes at least one of a QCI, an APN-AMBR, and an ARP that correspond to a default bearer, and the second QoS parameter includes at least one of a 5 QI, a session AMBR, and an ARP that correspond to a default QoS flow; or
the first QoS parameter includes at least one of a QCI, an APN-AMBR, and an ARP that correspond to a dedicated bearer, and the second QoS parameter includes at least one of a 5 QI, a GBR, and an ARP that correspond to a dedicated QoS flow.

Preferably, the first removal request may include release indication information. Alternatively, the first removal request includes the QoS parameter that corresponds to the service data flow and that is of the first communications network.

The communication resource release apparatus in the foregoing embodiment may be UE, or may be one of a PCF network element, an AMF network element, and a PGW-C network element. For example, when the communication resource release apparatus is the PGW-C network element, an action performed by the receiving unit 601 mainly corresponds to operation 301 in FIG. 4, and an action performed by the processing unit 602 mainly corresponds to operation 302 in FIG. 4. For another example, when the communication resource release apparatus is the SMF network element, an action performed by the receiving unit 601 mainly corresponds to operation 401 in FIG. 5, and an action performed by the processing unit 602 mainly corresponds to operation 402 in FIG. 4.

FIG. 7 is a schematic structural diagram of another communication resource release apparatus according to this application. The apparatus includes a communications interface 701, a processor 702, a memory 703, and a bus system 704.

The memory 703 is configured to store a program. Specifically, the program may include program code, and the program code includes a computer operation instruction. The memory 703 may be a random access memory (RAM), or may be a nonvolatile memory (NVM), for example, at least one magnetic disk storage. Only one memory is shown in the figure. Certainly, a plurality of memories may alternatively be set as required. The memory 703 may alternatively be a memory in the processor 702.

The memory 703 stores the following elements: an executable module or a data structure, a subset of an executable module or a data structure, or an extended set of an executable module or a data structure:
an operation instruction: including various operation instructions, used to implement various operations; and
an operating system: including various system programs, used to implement various basic services and process a hardware-based task.

The processor 702 controls an operation of the communication resource release apparatus 700, and the processor 702 may also be referred to as a central processing unit (CPU). During specific application, components of the network device 700 are coupled together by using the bus system 704. In addition to including a data bus, the bus system 704 may include a power bus, a control bus, a status signal bus, and the like. However, for clarity of description, various buses are denoted as the bus system 704 in the figure. For ease of representation, only illustrative depiction is provided in FIG. 7.

The methods disclosed in the foregoing embodiments of this application may be applied to the processor 702 or implemented by the processor 702. The processor 702 may be an integrated circuit chip and has a signal processing capability. In an implementation process, operations in the foregoing methods can be implemented by using a hardware integrated logic circuit in the processor 702, or by using instructions in a form of software. The processor 702 may be a general-purpose processor, a digital signal processor (DSP), an application-specific integrated circuit (ASIC), a field programmable gate array (FPGA) or another programmable logic device, a discrete gate or a transistor logic device, or a discrete hardware component. It may implement or perform the methods, the operations, and logical block diagrams that are disclosed in the embodiments of this application. The general-purpose processor may be a microprocessor, or the processor may be any conventional processor or the like. Operations of the methods disclosed with reference to the embodiments of this application may be directly performed and accomplished by using a hardware decoding processor, or may be performed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 703. The processor 702 reads information in the memory 703 and performs the operations of the foregoing methods in combination with hardware of the processor 702.

The communication resource release apparatus in the foregoing embodiment may be UE, or may be one of a PCF network element, an AMF network element, and a PGW-C network element. For example, when the communication resource release apparatus is the PGW-C network element, the PGW-C network element receives a first removal request from a PCRF by using the communications interface 701, sends an update bearer request to an SGW by using the communications interface 701, and the processor 702 in the PGW-C network element performs the processing process in operation 302. For another example, when the communication resource release apparatus is the SMF network element, the SMF network element receives the first removal request from the PCF by using the communications interface 701, and sends a second removal request to the AMF by using the communications interface 701, and the processor 702 in the SMF network element performs the processing process in operation 402.

Compared with a conventional resource release manner, in the communication resource release method provided in the embodiments of this application, while a network in which a terminal is currently located is released, a communication resource of a target network that interworks with a current network is also released. This ensures that the communication resource is not occupied, and interworking between the first communications network and the second communications network may be smoothly performed, thereby improving network resource utilization.

A person skilled in the art should understand that the embodiments of the present invention may be provided as a method, a system, or a computer program product. Therefore, the embodiments of the present invention may use a form of hardware only embodiments, software only embodiments, or embodiments with a combination of software and hardware. Moreover, the embodiments of the present invention may use a form of a computer program product that is implemented on one or more computer-usable storage media (including but not limited to a disk memory, a CD-ROM, an optical memory, and the like) that include computer-usable program code.

The embodiments of the present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and operations are performed on the computer or the another programmable device, thereby generating computer-implemented processing. Therefore, the instructions executed on the computer or the another programmable device provide operations for implementing a specific function in one or more processes in the flowcharts and/or in one or more blocks in the block diagrams.

Clearly, a person skilled in the art can make various modifications and variations to embodiments of the present invention without departing from the spirit and scope of this application. This application is intended to cover these modifications and variations provided that they fall within the scope of protection defined by the following claims and their equivalent technologies.

1. A communication resource release method, comprising:
receiving, by a first network element of a first communications network, a first removal request for a service data flow from a second network element; and
deleting, by the first network element based on the first removal request, a first quality of service (QoS) parameter that corresponds to the service data flow and that is of the first communications network and a second QoS parameter of a second communications network that corresponds to the service data flow and that is of a second communications network.

2. The method according to claim 1, wherein the method further comprises:
determining, by the first network element, that there is only one service data flow in a bearer that corresponds to the service data flow and that is of the second communications network; and
deleting, by the first network element, a bearer identifier of the bearer.

3. The method according to claim 1, wherein the method further comprises:
determining, by the first network element, that there is only one service data flow in a QoS flow that corresponds to the service data flow and that is of the second communications network; and
deleting, by the first network element, a quality of service flow identifier (QFI) of the QoS flow.

4. The method according to claim 2, wherein the first network element is a session management function (SMF) network element, the second network element is a terminal or a policy and charging function (PCF) network element, and the method further comprises:
sending, by the SMF network element, a second removal request to an access and mobility management function (AMF) network element of the first communications network, wherein the second removal request is used to request the AMF network element to release the bearer identifier of the bearer that corresponds to the service data flow and that is of the second communications network.

5. The method according to claim 3, wherein the first network element is a packet data network gateway control plane (PGW-C) network element, the second network element is a terminal or a policy and charging rules function (PCRF) network element, and the method further comprises:
releasing, by the PGW-C network element, the QFI of the QoS flow that corresponds to the bearer and that is of the second communications network.

6. The method according to claim 1, wherein
the first QoS parameter comprises at least one of a 5G QoS indicator (5 QI), a session aggregate maximum bit rate session (AMBR), and an allocation and retention priority (ARP) that correspond to a default QoS flow, and the second QoS parameter comprises at least one of a QoS classification identifier (QCI), an access point name-aggregate maximum bit rate (APN-AMBR), and an ARP that correspond to a default bearer; or
the first QoS parameter comprises at least one of a 5 QI, a guaranteed bit rate (GBR), and an ARP that correspond to a dedicated QoS flow, and the second QoS parameter comprises at least one of a QCI, an APN-AMBR, and an ARP that correspond to a dedicated bearer.

7. The method according to claim 1, wherein
the first QoS parameter comprises at least one of a QCI, an APN-AMBR, and an ARP that correspond to a default bearer, and the second QoS parameter comprises at least one of a 5 QI, a session AMBR, and an ARP that correspond to a default QoS flow; or
the first QoS parameter comprises at least one of a QCI, an APN-AMBR, and an ARP that correspond to a dedicated bearer, and the second QoS parameter comprises at least one of an 5 QI, a GBR, and an ARP that correspond to a dedicated QoS flow.

8. The method according to claim 1, wherein the first removal request comprises release indication information.

9. The method according to claim 1, wherein the first removal request comprises the QoS parameter that corresponds to the service data flow and that is of the first communications network.

10. The method according to claim 1, wherein the first network element is a terminal, and the second network element is an SMF network element or a PGW-C network element.

11. The method according to claim 1, wherein the first network element is a PCF network element or a PCRF network element, and the second network element is an SMF network element or a PGW-C network element.

12. The method according to claim 10, wherein before the receiving, by a first network element of a first communications network, a first removal request for a service data flow from a second network element, the method further comprises:
sending, by the first network element, a session removal request to the second network element.

13. A communication resource release apparatus, comprising a processor and a memory,
Wherein the processor invokes an instruction stored in the memory, to perform operations, the operations comprising:
receiving a first removal request for a service data flow from a second network element; and
deleting, based on the first removal request, a first quality of service (QoS) parameter that corresponds to the service data flow and that is of a first communications network and a second QoS parameter that corresponds to the service data flow and that is of a second communications network.

14. The communication resource release apparatus according to claim 13, wherein the operations further comprise:
determining that there is only one service data flow in a bearer that corresponds to the service data flow and that is of the second communications network; and
deleting a bearer identifier of the bearer.

15. The communication resource release apparatus according to claim 13, wherein the operations further comprise:
determining that there is only one service data flow in a QoS flow that corresponds to the service data flow and that is of the second communications network; and
deleting a quality of service flow identifier (QFI) of the QoS flow.

16. The communication resource release apparatus according to claim 14, wherein the second network element is a terminal or a policy and charging function (PCF) network element, and wherein the operations further comprise:
sending a second removal request for the service data flow to an access and mobility management function (AMF) network element of the first communications network, wherein the second removal request is used to request the AMF network element to release the bearer identifier of the bearer that corresponds to the service data flow and that is of the second communications network.

17. The communication resource release apparatus according to claim 15, wherein the second network element is a terminal or a policy and charging rules function (PCRF) network element, and wherein the operations further comprise:
releasing the QFI of the QoS flow that corresponds to the bearer and that is of the second communications network.

18. The communication resource release apparatus according to claim 13, wherein
the first QoS parameter comprises at least one of a 5G QoS indicator (5 QI), a session aggregate maximum bit rate session (AMBR), and an allocation and retention priority (ARP) that correspond to a default QoS flow, and the second QoS parameter comprises at least one of a QoS classification identifier (QCI), an access point name-aggregate maximum bit rate (APN-AMBR), and an ARP that correspond to a default bearer; or
the first QoS parameter comprises at least one of a 5 QI, a guaranteed bit rate (GBR), and an ARP that correspond to a dedicated QoS flow, and the second QoS parameter comprises at least one of a QCI, an APN-AMBR, and an ARP that correspond to a dedicated bearer.

19. The communication resource release apparatus according to claim 13, wherein
the first QoS parameter comprises at least one of a QCI, an APN-AMBR, and an ARP that correspond to a default bearer, and the second QoS parameter comprises at least one of a 5 QI, a session AMBR, and an ARP that correspond to a default QoS flow; or
the first QoS parameter comprises at least one of a QCI, an APN-AMBR, and an ARP that correspond to a dedicated bearer, and the second QoS parameter comprises at least one of a 5 QI, a GBR, and an ARP that correspond to a dedicated QoS flow.

20. A non-transient computer storage medium, wherein the non-transient computer-readable storage medium stores a computer-executable instruction, and the computer-executable instruction is used to enable a computer to perform operations, the operations comprising:
receiving, by a first network element of a first communications network, a first removal request for a service data flow from a second network element; and
deleting, by the first network element based on the first removal request, a first quality of service (QoS) parameter that corresponds to the service data flow and that is of the first communications network and a second QoS parameter of a second communications network that corresponds to the service data flow and that is of a second communications network.
